(19) United States
(12) Patent Application Publication
(10) Pub. No.: US 2012/0255526 A1
(43) Pub. Date: Oct. 11, 2012

(54) PISTON ENGINE

(76) Inventor: Lars Ola Liavåg, Vasa (FI)

(21) Appl. No.: 13/516,558

(22) PCT Filed: Dec. 16, 2010
(86) PCT No.: PCT/FI2010/051047

§ 371 Date: Jun. 15, 2012

(30) Foreign Application Priority Data
Dec. 18, 2009 (FI) 20096353

(51) Int. Cl. F02M 25/028; F02B 29/04

(52) U.S. Cl. 123/542

(57) ABSTRACT

The invention relates to a piston engine comprising an intake air duct (2) for conducting intake air into cylinders (3) of the engine (1). The intake air duct (2) is provided with liquid removal means (15) for removing liquid from an inner surface (19) of the intake air duct (2).

### BACKGROUND OF THE INVENTION

1. Field of the Invention

The invention relates to a piston engine.

2. Brief Discussion of the Related Art

Nitrogen oxides (NOx) are formed in high combustion temperatures in cylinders of a piston engine and conveyed into the atmosphere with the exhaust gases. Because of the negative environmental effects of the nitrogen oxide emissions, efforts have been made to minimise them. Adding water to the combustion air reduces the nitrogen oxide emissions. Water reduces the combustion temperature in the cylinder, whereby the amount of nitrogen oxides formed is reduced. In practice, adding water to the combustion process of a piston engine is carried out in two alternative ways: water can be injected either directly into the cylinders or it can be mixed with the combustion air prior to introducing it into the cylinders.

As water is mixed with the combustion air prior to introducing to cylinders, a liquid water film may form on the inner surface of the intake air duct and other surfaces being in contact with the intake air due to the impingement of liquid droplets on these surfaces. This film is subsequently transported by aerodynamic forces in the downstream direction and the water contained therein may therefore spread to large parts of the intake air duct and into the charge air cooler, giving rise to corrosion and other, related problems. For example, the intake air flow can release large water drops from the water film, which drops may subsequently impact onto the surfaces of the charge air cooler or other components and thus cause damages.

Document U.S. Pat. No. 3,832,985 discloses a piston engine, in which an intake air duct is provided with a liquid removal means for removing liquid from an inner surface of the intake air duct. This subject matter is also disclosed by documents GB-A-1.258.261 and DE-A-24.46.490.

### SUMMARY OF THE INVENTION

The object of the present invention is to reduce the above problems.

The object of the invention is met as is disclosed in claim 1. A piston engine according to the invention comprises an intake air duct for conducting intake air into cylinders of the engine. The intake air duct is provided with liquid removal means for removing liquid from an inner surface of the intake air duct. Additionally, a charge air cooler is connected to the intake air duct and the liquid removal means are arranged before the charge air cooler in the flow direction of the intake air.

Significant benefits can be achieved by means of the invention. A liquid film collected on the inner surface of the intake air duct can be removed by the liquid removal means. As a result, the amount of liquid on the intake air duct inner surface is reduced as well as corrosion and other problems caused by the liquid.

### BRIEF DISCUSSION OF THE DRAWINGS

In the following the invention is be described, by way of example, with reference to the accompanying drawings, in which

FIG. 1 is a schematic view of a piston engine.

FIG. 2 is a cross sectional view of the partial enlargement A of FIG. 1.

### DETAILED DISCUSSION OF THE PREFERRED EMBODIMENTS

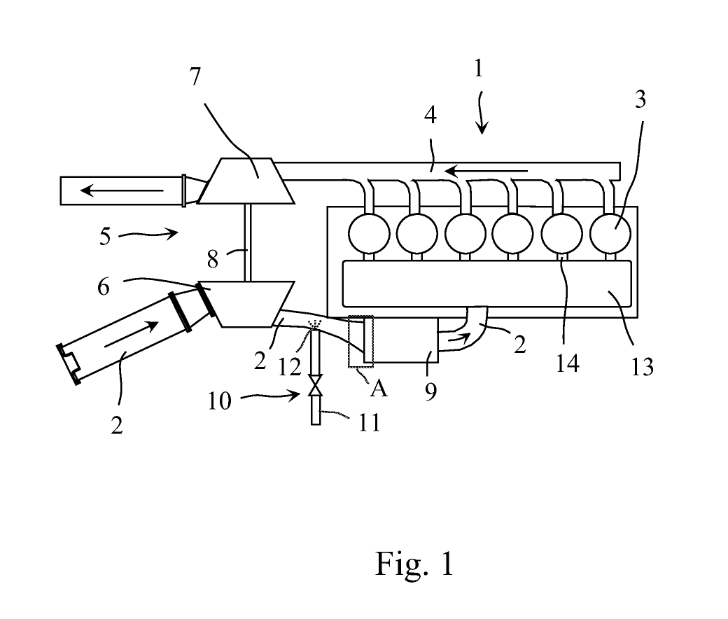

FIG. 1 is a schematic view of a large piston engine 1. Large piston engine refers here to such engines that can be used for instance as main and auxiliary engines in ships or in power plants for production of heat and/or electricity. The engine 1 comprises an in-take air duct 2 for conducting intake air into cylinders 3 of the engine. The engine 1 comprises an exhaust gas duct 4 through which exhaust gas is discharged from the cylinders 3. Further, the engine 1 comprises a turbocharger 5 provided with a compressor 6 and a turbine 7. The compressor 6 and the turbine 7 are connected to each other via a drive shaft 8. The compressor 6 is connected to the intake air duct 2. The turbine 7 is connected to the exhaust gas duct 4. A charge air cooler 9 is connected to the intake air duct 2 downstream of the compressor 6. The charge air cooler 9 is arranged to cool the intake air pressurized by the compressor 6. A generator (not shown) can be connected to the engine 1.

The intake air duct 2 is provided with liquid feeding means 10 for feeding liquid, e.g. water, into the intake air duct 2. The liquid feeding means 10 are arranged to feed liquid into intake air duct 2 at a location after the compressor 6 but before the charge air cooler 9 in the flow direction of the intake air. By feeding liquid into intake air duct 2, the moisture content of the intake air can be increased. Moistening the intake air reduces the amount of nitrogen oxides (NOx) formed in the combustion in the cylinders 3. Liquid is mixed with the combustion air in the intake air duct 2 before introducing the intake air into the charge air cooler 9. The liquid feeding means 10 comprise a feed tube 11 connected to a liquid source. Nozzles 12 opening into the intake air duct 2 are connected to the feed tube 12. From the nozzles 12 liquid is introduced in drop or mist form into the intake air duct 2.

The intake air duct 2 comprises a charge air receiver 13, which is arranged downstream of the charge air cooler 9. The intake air duct 2 also comprises inlet channels 14 arranged between each cylinder 3 and the charge air receiver 13 for introducing combustion air from the charge air receiver 13 to the cylinders 3.

The intake air duct 2 is provided with liquid removal means for removing a liquid film from the inner surface 19 of the intake duct 2. Liquid film may form on the inner surface(s) of the intake air duct due to the impingement of liquid droplets on the surface(s).

The droplets may originate from liquid fed by the liquid feeding means 10 and/or humidity in ambient air. The liquid film is transported by aerodynamic forces in the downstream direction and the liquid may spread onto large areas of the intake air duct surfaces.

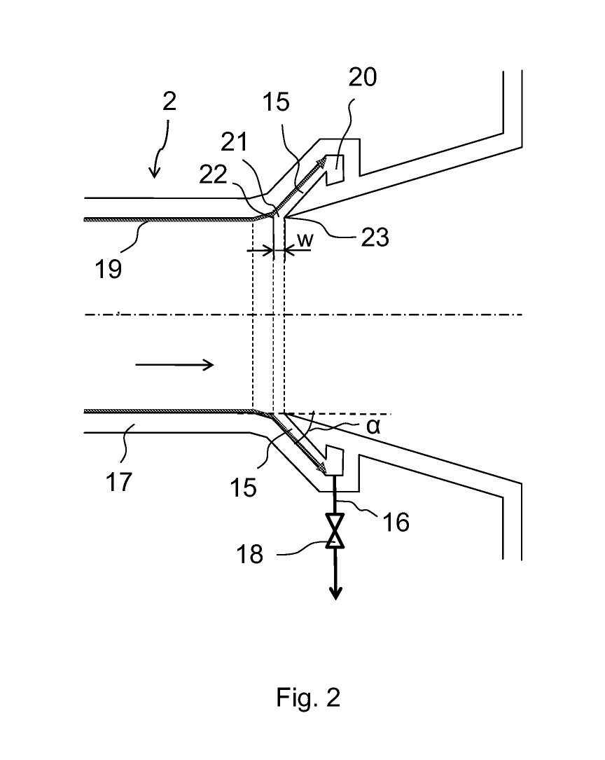

According to an embodiment shown in FIG. 2 of the invention, the liquid removal means comprise a slot 15 arranged in a wall 17 of the intake air duct 2. The slot 15 opens into the intake air duct 2. The slot 15 is arranged after the liquid feeding means 10 in the flow direction of the intake air. A drain 16 is connected to the slot 15. Liquid can be removed from the slot 15 through the drain 16. The drain 16 arranged at the lowest part of the slot 15. The drain 16 comprises a valve 18, e.g. a float controlled valve, which is arranged to open as the liquid level in the slot 15 or in the drain 16 rises over a predetermined level.

The slot 15 is elongated in the transverse direction of the intake air duct 2. The slot 15 can extend around the entire perimeter of the intake air duct 2. Alternatively, the slot 15 can extent extend around only a portion of the perimeter of the slot 15. The slot 15 extends away from the inner surface 19. The slot 15 extends away from the inner surface 19 at an angle (α) of at most 85°, typically at an angle of 5-70°. The width (w) of the slot 15 depends on the volume and thickness of the liquid film to be removed as well as flow conditions of the intake air in the intake air duct 2. Typically, the thickness of the liquid film is at most 2.4 mm. The width (w) is at least 3 mm, typically 1-5 cm. The bottom of the slot 15 comprises a settling chamber 20 through which liquid to be collected flows to the lowest part of the slot 15.

The opening 21 of the slot 15 is arranged on the inner surface 19 of the intake air duct 2. The opening 21 of the slot comprises a front edge 22 and a rear edge 23. The rear edge 23 is located downstream from the front edge 22. The inner diameter of the intake air duct 2 at the location of the rear edge 23 is equal or larger than that at the location of the front edge 22.

When the engine 1 is running, intake air is conducted to the compressor 6, by which its pressure is raised to about 4 bar. Thereafter, the moisture content of the intake air is increased by feeding liquid into the intake air duct 2. Then, the liquid film formed on the inner surface 19 of the intake air duct 2 is removed by the liquid removal means. When the liquid removal means comprise the slot 15, the aerodynamic forces caused by the intake air flow urge liquid from the liquid film into the slot 15. In the slot 15 liquid flows to the settling chamber 20. Liquid flows through the settling chamber 20 to the lowest part of the slot 15. As the liquid level in the slot 15 or drain 16 rises over a predetermined level, the valve 18 opens and liquid flows out of the slot 15 through the drain 16.

Thereafter, the intake air is led to the charge air cooler 9 and cooled by the cooler 9. Cooled intake air is led to the charge air receiver 13. From the charge air receiver 13 the intake air is directed along inlet channels 14 into cylinders 3. Fuel is combusted with intake air in the cylinders 3. The exhaust gas formed in the combustion is directed along the exhaust gas duct 4 to the turbine 4. As the flow traverses the turbine 4, it rotates the rotor of the turbine 4, the rotation of which is transmitted via drive shaft 8 to the rotor of the compressor 3. The flow directions of the intake air and the exhaust gas are shown by arrows in the drawings.

1. A piston engine comprises an intake air duct for conducting intake air into cylinders of the engine, a charge air cooler connected to the intake air duct, the intake air duct being provided with liquid removal means for removing liquid from an inner surface of the intake air duct, the liquid removal means being arranged before the charge air cooler in the flow direction of the intake air, wherein:
the liquid removal means comprise a slot arranged in a wall of the intake air duct,
a drain is connected to the slot, through which drain the liquid can be removed from the slot, and
the drain comprises a valve, which is arranged to open as the liquid level in the slot or in the drain rises over a predetermined level.

2. The piston engine according to claim 1, wherein the slot is elongated in the transverse direction of the intake air duct.

3. The piston engine according to claim 1, wherein the slot extends around the entire perimeter of the intake air duct.

4. The piston engine according to claim 1, wherein the slot extends away from the inner surface of the intake air duct.

5. The piston engine according to claim 4, wherein the slot extends at an angle (α) of at most 85°, away from the inner surface of the intake air duct.

6. The piston engine according to claim 1, wherein the width (w) of the slot is at least 3 mm.

7. The piston engine according to claim 1, wherein the intake air duct is provided with liquid feeding means for feeding liquid into the intake air duct, and that the liquid removal means are arranged after the liquid feeding means in the flow direction of the intake air.

8. The piston engine according to claim 1, wherein an opening of the slot comprises a front edge and a rear edge located downstream from the front edge, and that the inner diameter of the intake air duct at the location of the front edge is equal or larger than that at the location of the rear edge.

9. The piston engine according to claim 5, wherein the angle (α) is 5-70°.

10. The piston engine according to claim 6, wherein the width (w) of the slot is 1-5 cm.
